(19) United States
(12) Patent Application Publication
(10) Pub. No.: US 2012/0101964 A1
(43) Pub. Date: Apr. 26, 2012

(54) METHOD FOR CATERING AN AIRCRAFT

(75) Inventors: Roger Keirn, Austin, TX (US); Craig Pyfer, Puyallup, WA (US); Bill J. Brock, Henderson, NV (US); Elizabeth Parker, Denver, CO (US)

(73) Assignee: Arlington Services, Inc.

(21) Appl. No.: 12/909,656

(22) Filed: Oct. 21, 2010

(51) Int. Cl. G06Q 90/00

(52) U.S. Cl. 705/500

(57) ABSTRACT

A method for catering an aircraft includes the steps of assembling products for multiple aircraft in a distribution center, segregating such products by specific aircraft, loading onto a delivery vehicle products for catering to a specific aircraft, and catering such products to such specific aircraft, the delivery vehicle containing only products for catering to one specific aircraft and not products for catering to multiple aircraft.

### FIELD OF THE INVENTION

The present invention relates to aircraft catering, more particularly to methods of distributing food products to passengers of airlines, and even more particularly, to methods for operating on a regular interval time basis despite changing conditions of an airline aircraft schedule.

### BACKGROUND OF THE INVENTION

The logistics of servicing an aircraft in preparation for flight can be complex. Traditional airline caterers often purchase pre-packaged foods from vendors and/or purchase food ingredients which are cooked and prepared in off-site kitchens. The food is then placed in packaging onto trays which are subsequently loaded into trolleys. Traditionally, multiple trolleys are loaded onto specialized catering trucks (requiring highly skilled drivers) at the kitchen or central distribution facility to service multiple flights. Drivers then drive to a designated aircraft and then cater that aircraft. Once the first aircraft has been catered, the driver moves on to the second aircraft, etc., until all of the flights that were loaded on the truck have been catered. After the driver has catered all assigned aircraft, the driver returns to the kitchen or other facility and re-loads, then repeats the process again.

To reduce the number of drivers making trips back and forth to the distribution center, and also to reduce the number of trips, multiple flights are loaded for each trip. Because truck size and amount of equipment needed by flight varies, the number of flights per truck also varies. It is not uncommon for drivers to leave the kitchen/distribution facility and not return for 3 or more hours. Such traditional airline catering methods require highly skilled drivers to operate expensive catering trucks which are necessary in order to dock to, and cater, a particular aircraft. Due to the complexities and unpredictability of airline schedules and constant changing parameters, airline caterers must adjust their delivery schedules and labor forces in order to meet the needs of the airlines operating in a constantly changing environment. This, in turn, results in inefficient distribution and utilization of catering resources and ultimately lost productivity.

### SUMMARY OF THE INVENTION

It is an object of the present invention to provide a more efficient distribution system.

In one embodiment of the present invention a method of catering an aircraft is provided including the steps of assembling products for multiple aircraft in a distribution center, segregating such products by specific aircraft, loading onto a delivery vehicle products for catering to a specific aircraft, and catering such products to such specific aircraft. In such embodiment, the delivery vehicle contains only products for catering to one specific aircraft and does not contain products for catering to multiple aircraft.

In another embodiment of the present invention there is provided a distribution system for catering aircraft, the method including assembling products for catering to multiple aircraft at a first distribution center, wherein the first distribution center is located outside the airport operational area, transporting such products from the first distribution center to a second distribution center, the second distribution center being located inside the airport operational area and delivering such products from the second distribution center to an aircraft utilizing a delivery vehicle that contains products for only one aircraft and not multiple aircraft.

In yet another embodiment of the present invention there is provided a method of operating an aircraft catering distribution system on a regular interval time basis despite changing conditions of an airline aircraft schedule due to uncontrollable factors such as weather. Such method includes assembling products for catering to multiple aircraft at a first distribution center located outside the airport operational area wherein the products assembled at such first distribution center are in bulk and are ready for delivery to an aircraft and require no further disassembly or assembly upon departure from the first distribution center, transporting such products from the first distribution center to a second distribution center utilizing a first delivery vehicle, wherein the first delivery vehicle is not adapted for docking to an aircraft, and wherein the second distribution center is located inside the airport operational area; at the second distribution center, segregating such products that will be catered to specific multiple aircraft, and thereafter, delivering such products from the second distribution center to an aircraft utilizing a second delivery vehicle, wherein the second delivery vehicle is different from the first delivery vehicle and which can dock with an aircraft. Such catering distribution system is operated on a regular interval time basis despite changing conditions of an airline aircraft schedule.

### BRIEF DESCRIPTION OF THE DRAWINGS

These and other details and aspects of the invention, as well as the advantages thereof, will be more readily understood and appreciated by those skilled in the art from the following detailed description, taken in conjunction with the accompanying drawings, in which:

FIG. 1 is a diagram which illustrates a traditional means of catering an aircraft.

FIG. 2A and FIG. 2B provide an illustration of a delivery truck which may be utilized in catering aircraft in accordance with the present invention.

FIG. 3 is a graphical representation of an example daily flight schedule of two commercial airlines.

FIG. 4 is a flow diagram of time spent on various activities by catering teams catering the example flight schedule of FIG. 3 utilizing the traditional means of catering referenced in FIG. 1.

FIG. 5 is a diagram which illustrates a system of catering aircraft in accordance with one embodiment of the present invention.

FIG. 6 is a flow diagram of time spent on various activities by catering teams catering the example flight schedule of FIG. 3 utilizing the system of catering aircraft referenced in FIG. 5.

FIG. 7 is a table which complies the data of FIG. 4 and FIG. 6 and illustrates advantages of utilizing methods in accordance with the present invention.

FIG. 8 is a graphical representation of the example daily flight schedule of FIG. 3, with additional shuttle flight distribution data.

### DESCRIPTION OF THE PREFERRED EMBODIMENTS OF THE INVENTION

Food products catered to aircraft, in particular, aircrafts of commercial airlines, are typically pre-packaged with the end passenger/consumer in mind. Generally, the food products consist of meals (entre, side dish, desert) and/or snacks, and often will be arranged into specific carriers and/or trays designed to be loaded and unloaded onto an aircraft as described more in detail below. Once the food products have been loaded onto an aircraft, the food is distributed to passengers by flight personnel, as determined by the particular airline's servicing requirements. During flight, food is consumed by passengers, and other waste is generated (e.g., empty soda cans, paper products, packaging materials, and other trash). Once the aircraft has landed at its destination, this “in-bound” material must be removed from the plane and discarded. The plane must then be replenished with new consumable products as well as food for the upcoming flight. This continuing cycle of servicing the various needs of an aircraft and its passengers is referred to as airline catering.

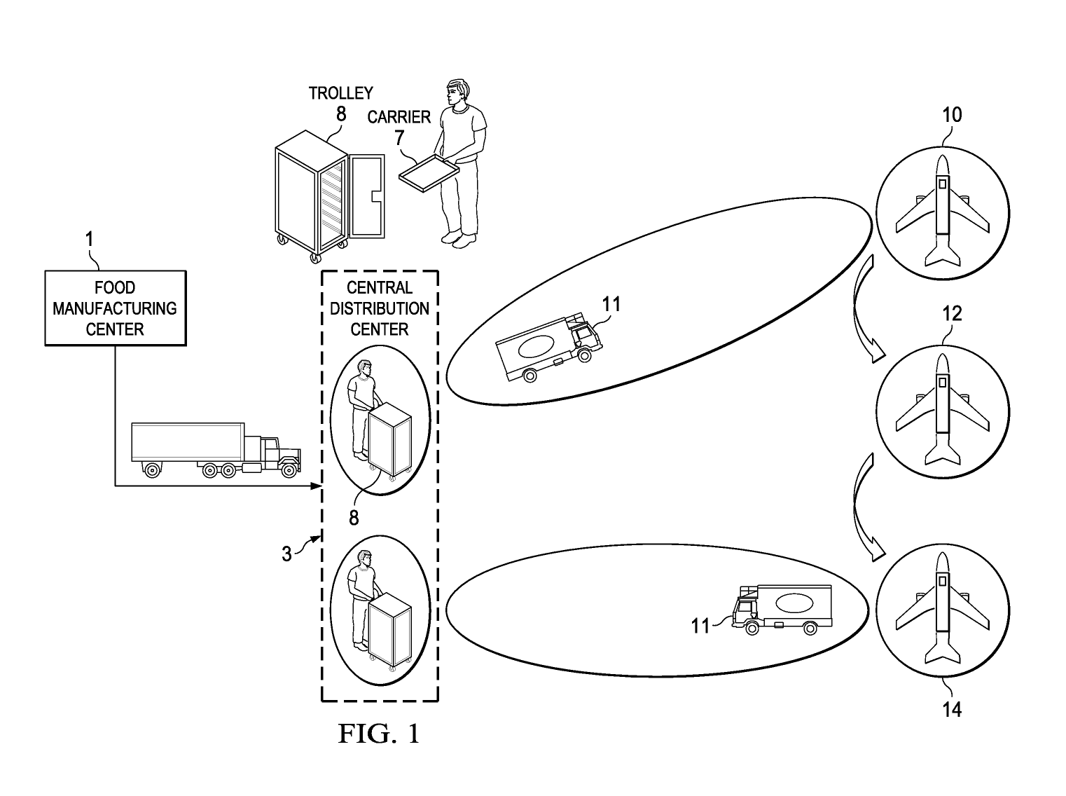

Referring now to FIG. 1, a diagram is shown illustrating how aircraft are traditionally catered. Food products are typically first manufactured and/or assembled at a food manufacturing center 1 off-site. Once the food products have been manufactured and/or assembled, the food is delivered from the manufacturing center or centers to a central distribution center 3 at or near the airport. At the central distribution center 3, the food is placed into carriers 7 in accordance with an order made by the airline. The carriers 7 will hold a designated number of any type of food products or a mixture of food products, depending on the order placed. For example, carriers 7 may include multiple individual complete meals, each meal having individual components (for example, an entre, side and desert). Carriers 7 may also, for example, contain a large quantity of individual pre-packaged items, such as crackers, peanuts, pretzels, etc. Carriers 7 may also contain non-food products.

At the central distribution center 3, the carriers 7 are loaded into trolleys 8. Trolleys 8 typically consist of a cart with multiple compartments to house carriers 7. Trolleys 8 typically contain wheels to enable the trolley to be loaded and unloaded onto an aircraft easily, and further to enable the trolleys 8 to be easily maneuvered about the aircraft. The number of carriers 7 loaded into the trolleys 8 and the number of trolleys 8 will depend upon the order placed by a particular airline for a given aircraft. Generally, multiple carriers 7 loaded on multiple trolleys 8 will be loaded onto truck 11 for distribution to multiple aircraft.

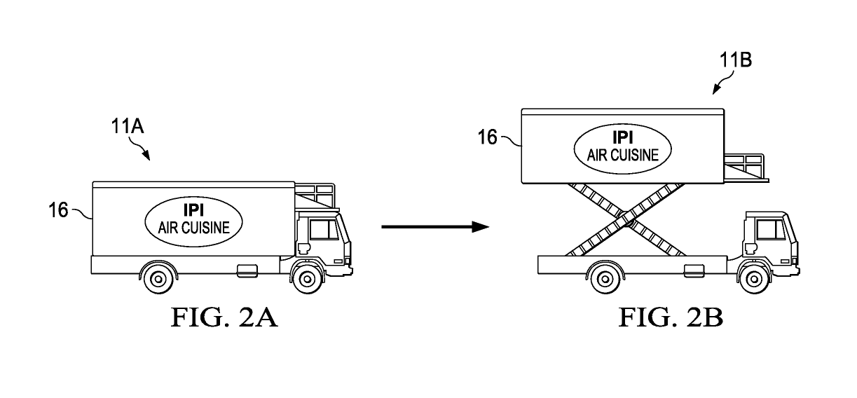

Truck 11 generally is a specialized truck suitable for transporting and delivering catering products to aircraft and has a specialized compartment 16 that can be elevated/raised to the cargo door of an aircraft and “dock” with the aircraft. FIG. 2A and FIG. 2B illustrate two configurations of truck 11: a lowered, transport mode “A” (FIG. 2A) and an elevated, “docking” mode “B” (FIG. 2B). The specialized compartment 16 of the truck 11 will often comprise a refrigeration unit and other specialized compartment or compartments in which the trolleys 8 are stored in transit between the distribution center 3 and the aircraft to be catered. As it will be appreciated, due to the specialized nature of truck 11, truck 11 is typically expensive and requires a driver or drivers with a specialized skill set. The specialized skill set includes, among others, the ability to effectively operate the lift mechanism of the truck 11 and the ability to “dock” with an aircraft. Truck 11 is typically more expensive and requires a more highly specialized driver than traditional transport trucks, and are also more expensive to operate.

Referring again to FIG. 1, multiple flights or galleys (multiple orders for multiple flights) of trolleys 8 are loaded onto truck 11 at the central distribution center 3. Typically the central distribution center 3 is located outside of the Airport Operational Area (“AOA”). The AOA generally encompasses all areas of the airport (land or lands designated as the airport including facilities and boundaries which may be modified from time to time) including runways and taxiways, and other areas adjacent to the airport which are designated to be used or intended to be used for aeronautical activities including the landing, takeoff, run-up or surface maneuvering of aircraft.

Once the galleys have been loaded, the trucks are then driven to the first designated aircraft for catering 10. Once aircraft 10 has been catered, the driver then moves on to the second aircraft 12 and then caters that aircraft. Once aircraft 12 has been catered, the driver then moves on to the third aircraft 14 and caters that aircraft. Once the driver has catered all the aircraft that were loaded onto the truck 11 at the distribution center 3, the driver then returns to the distribution center 3 to re-load with new food products, and also dispose of in-bound material. Once more food products in galleys are loaded, the driver then repeats the process.

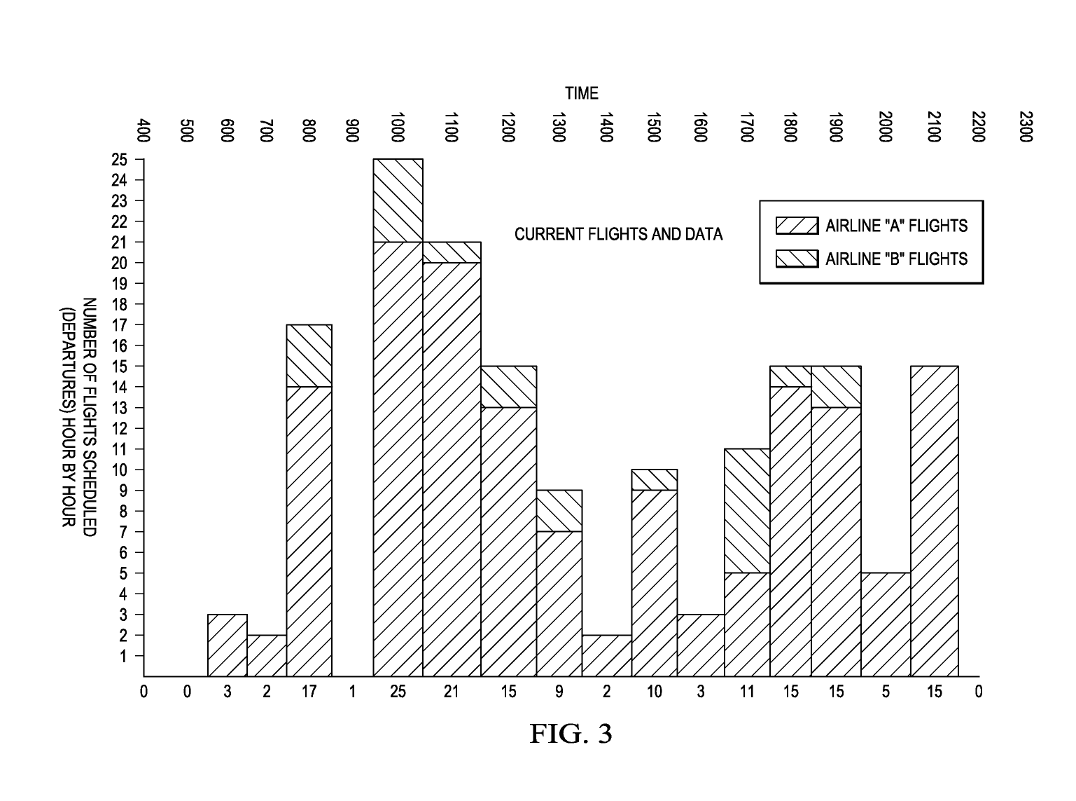

Turning now to FIG. 3, there is shown a diagram illustrating an example of a typical daily flight distribution schedule of two commercial airlines (designated as Airline “A” and Airline “B”) at a domestic international airport. As shown in FIG. 3, flights are scheduled at various times during the day, with the majority of flights occurring between the hours of 10:00 AM and 08:00 PM. For example, between 08:00 AM and 09:00 AM, there are 14 flights scheduled for Airline “A” and 17 flights scheduled for Airline “B”. Between 10:00 AM and 11:00 AM there are 21 flights scheduled for Airline “A” and 25 flights scheduled for Airline “B”.

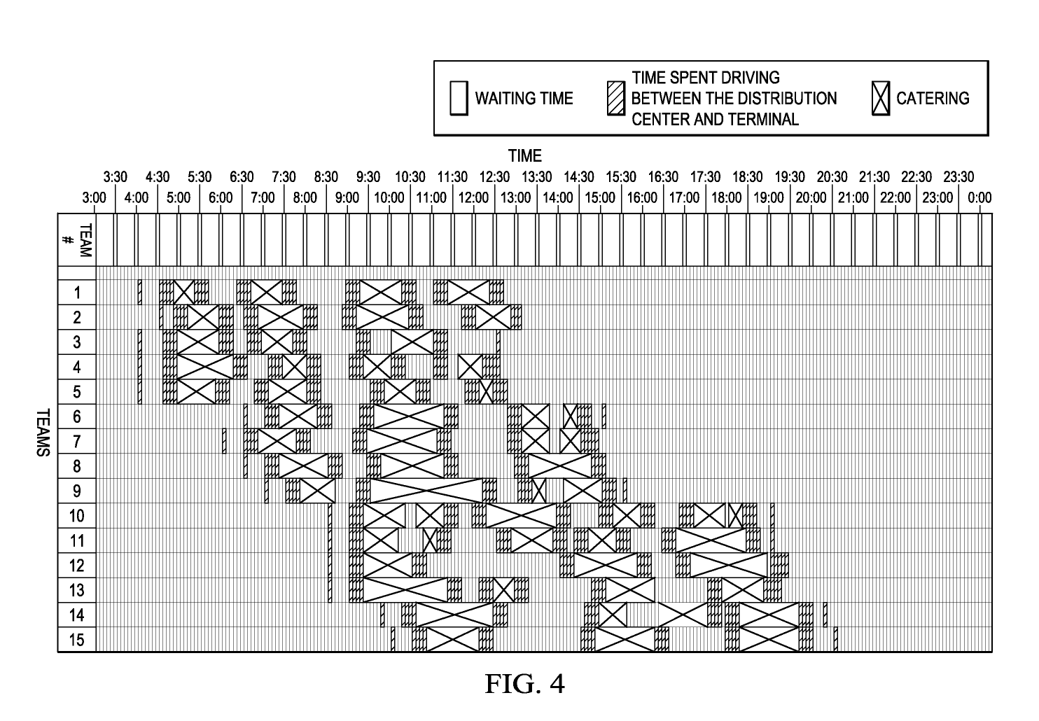

To illustrate the impact of Applicants' novel system and method of distribution described further below, Applicants documented time spent catering each of the flights shown in FIG. 3 using the traditional means of catering referenced in FIG. 1. The results of Applicants' time studies are illustrated in FIG. 4.

As shown in FIG. 4, there is shown a flow diagram of time spent on various activities by catering teams catering the example flight schedule of FIG. 3 utilizing the traditional means of catering referenced in FIG. 1. In this example, 15 teams of drivers (denoted in FIG. 4 as Team #1, Team #2, etc.) were studied to determine the amount of time each team actually spent catering an aircraft during a given day using the traditional catering method illustrated in FIG. 1. The time slots marked with an “X” represent time spent actually catering the various aircraft of a given load run. The time slots with diagonal lines represent travel time (between the central distribution center 3 and aircraft). The time slots that do not contain any marking represent unloading/loading time and waiting time between deliveries. In this example, some teams referenced utilized a “split catering” team approach. Under a “split catering” team approach, two sets of drivers are required per catered aircraft. In some instances, one team will cater the front of the aircraft, and another team with catering the back of an aircraft.

Referring to the specific time activities referenced in FIG. 4, reference is made to Team 1. As shown, Team 1 leaves the central distribution center 3 at 04:30 AM and drives to the terminal. At 04:50 AM, Team 1 begins catering aircraft, one at a time, until all the food products which have been loaded in Team 1's truck have been delivered to the designated aircrafts. At 05:20 AM, Team 1 finishes catering the aircraft and receiving in-bound materials, and then subsequently returns to the central distribution center 3 at 05:40 AM. Between 05:40 AM and 06:20 AM, Team 1's truck of inbound material is unloaded, and then is re-loaded with additional food products for subsequent flights. At 06:20 AM, Team 1 again leaves the central distribution center 3 and arrives at the terminal at 06:40 AM, where it repeats the process of catering multiple aircraft until all aircraft have been catered. At 07:25 AM, Team 1 finishes and returns to the central distribution center 20 minutes later at 07:45 AM, where it again repeats the process.

Still referring to FIG. 4, using Team 9 as an example, it can be seen where Team 9, during its second “run”, leaves the central distribution center 3 at 09:10 AM and arrives at the terminal 20 minutes later at 09:30 AM. From 09:30 AM until 12:05 PM, Team 9 is catering multiple aircraft. Once all aircraft assigned to Team 9 have been catered, Team 9 returns to the central distribution center 3 at 12:25 PM, approximately 3 hours from when it left.

As reflected by the data in FIG. 4, there is considerable variation in the time spent by various drivers during similar time periods of the day. This is due, in part, to the fact that multiple flights are being catered on each truck and each truck contains different numbers of flights. The variation is also due, in part, to the fact that there can be considerable variations in airline schedules. The reasons for this situation are complex and varied, but include considerations such as the interdependence of the airlines and their use of shared airport facilities, extensive governmental regulations, and the impact of the uncontrollable schedules of competitor's aircraft. Many different elements can impact the schedule of an aircraft including passenger ticketing issues, aircraft servicing issues (e.g., loading of fuel, food, cargo), baggage and cargo loading issues, competitors' needs for use of the common assets (uncontrolled aircraft requiring access to the common assets), security issues/breaches, and weather-related issues. These issues are compounded considering that multiple aircraft are involved (each having the same possibility of issues) of numerous carriers.

This situation is illustrated by the following example of a hypothetical flight arrival schedule. Airline A schedules Flight 1 to arrive at Gate 25 at 07:10 AM and schedules Flight 2 to arrive at Gate 25 one hour later at 08:10 AM. Airline A also schedules 3 other flight arrivals (Flights 3, 4 and 5) at different gates for various times. Airline A subsequently instructs the airline caterer of this flight schedule and of its corresponding meal requirements. Using the traditional catering method referenced in FIG. 1, the airline caterer subsequently fills the order at the central distribution center 3 and loads the orders onto truck 11 and then sends the truck into the field.

It is subsequently discovered that Flight 1 will not make its 07:10 arrival schedule and will not arrive at gate 25 until 07:45 AM, and will be at gate 25 until 08:15 AM. The airline then makes the decision to change Flight 2's gate arrival time from 08:10 AM to 08:15 AM. However, because of low visibility weather conditions, Flight 2 is further delayed, and is given a final gate arrival time of 08:26 AM.

Using the traditional catering method referenced in FIG. 1, the catering team caters Flight 1 at 7:45 AM. As referred to above, the catering team also has loaded on its truck catering items for Flight 2 (which now has been delayed until 8:26 AM), as well as Flights 3-5. If Flight 2 had arrived on time at 8:15 AM, the catering truck would have been able to cater Flight 2 upon its arrival at the arrival gate with no delays. However, because Flight 2 is delayed, the catering team cannot cater this flight yet. The 3 other flights (Flights 3-5) loaded on its truck are scheduled to be delivered at 8:30 AM, 8:50 AM and 9:10 AM. The 8:30 AM flight (Flight 3) is also on time, but the flight that was delayed (Flight 2) due to weather has now arrived at 08:26 AM, and the team must now go back and cater Flight 2. In doing so, it is late to cater Flight 3 which arrived at 8:30 AM. This delay, unfortunately, causes Flight 3 to be delayed in departing.

As it can be seen, the problem is further complicated when there are multiple aircraft involved as well as multiple airlines.

In utilizing the traditional catering approach described above and illustrated in FIG. 1, the central distribution center 3 necessarily is required to respond and adjust its operation schedule depending on the flow of trucks 11 in and out of the central distribution center 3. In addition, the traditional catering approach is based on the estimated time of departure of the aircraft, which, as illustrated above, can vary dramatically. It may be, for example, that multiple trucks arrive for loading at the same time, depending on how the trucks fared in the field, or if they were delayed due to schedule fluctuations. This can result in increased labor force requirements and expenses, dramatic fluctuations in time allocations and productivity, and otherwise is unpredictable.

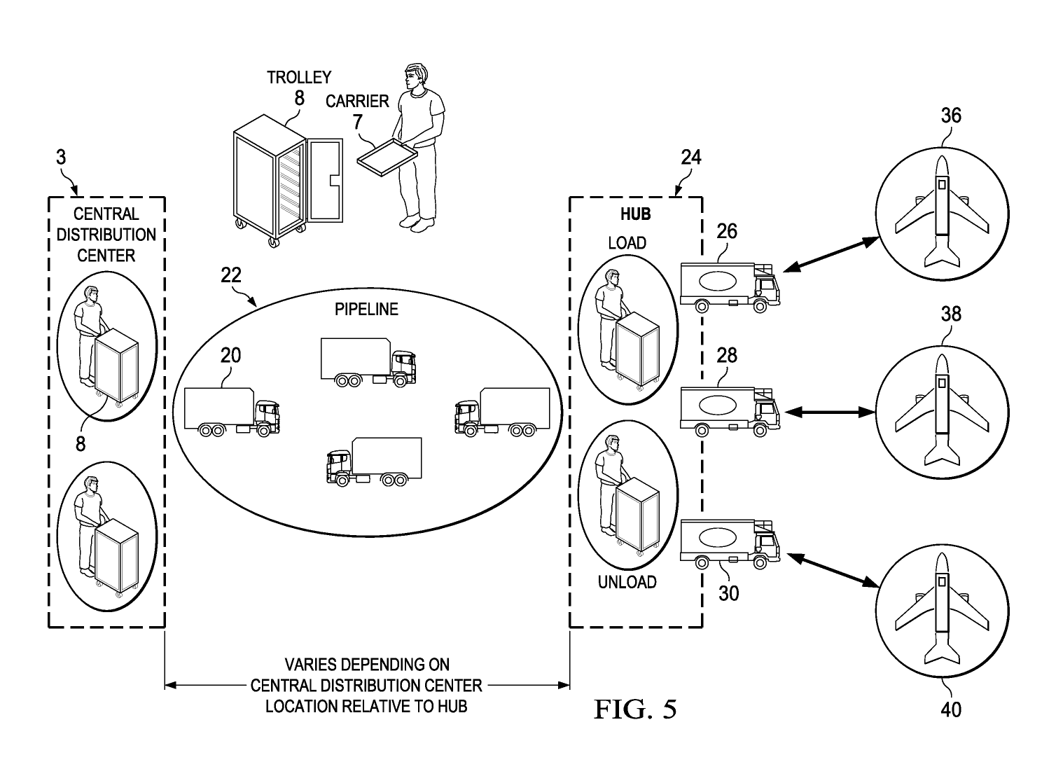

Referring now to FIG. 5, there is shown a schematic diagram of the improved distribution system in accordance with the present invention. Food products manufactured and/or assembled off-site are first delivered to a central distribution center 3. The central distribution center 3 is preferably located at or near the airport and may be located inside or outside the AOA. In one embodiment of the present invention, the central distribution center 3 is located outside the AOA. At the central distribution center 3, food is placed into carriers 7 and thereafter loaded into trolleys 8. Once the trolleys 8 have been loaded with carriers 7, they are then loaded onto shuttle vehicles 20. Generally, products assembled at the central distribution center 3 are for multiple aircrafts. Preferably, such products are assembled in bulk and are ready for delivery to aircraft and require no further disassembly or assembly after departure from the central distribution center 3.

Shuttle vehicles 20 can be, but preferably are not, adapted with a specialized lift mechanism to enable it to “dock” to an aircraft. Rather, shuttle vehicles 20 may be any type of transport vehicle. Shuttle vehicles 20 carry the food products between the central distribution center 3 and a hub distribution center 24, the area/distance between the central distribution center 3 and the hub distribution center 24 referred to as the pipeline 22.

Shuttle vehicles 20 are typically inexpensive (as compared to the more specialized catering lift/dock trucks) and also do not require a driver with a specialized skill set (as compared to drivers of catering lift/dock trucks. Such shuttle vehicles 20 are also less expensive to operate (as compared to the specialized catering truck).

The hub distribution center 24 is preferably located inside the AOA, but may be alternatively located outside the AOA. Preferably, the hub distribution center 24 is located in close proximity to the aircraft being catered. The hub distribution center 24 may, for example, consist of a permanent structure, such as a building, warehouse or other facility, or may consist of, for example, a temporary facility or mobile facility, including for example, a transport vehicle, trailer, tent, and the like or combinations thereof. The hub distribution center 24 may also consist of a combination of permanent, temporary and mobile facilities. When a shuttle truck 20 arrives at the hub distribution center 24, the trolleys 8 are unloaded at the hub distribution center 24 where they are placed in a “queue.” The trolleys 8 are then built and assembled depending on the particular flight requirements and schedules. In one embodiment of the present invention, the flights are assembled based on estimated time of arrival of the aircraft. Preferably, multiple flights are assembled first in the queue, prior to loading onto specific catering trucks, designated in FIG. 5, for example, as catering trucks 26, 28 and 30. Catering trucks 26, 28, 30 are generally specialized trucks suitable for transporting and delivering food and other products to aircraft. Generally, catering trucks 26, 28, 30 have a specialized compartment that can be elevated/raised to the cargo door of the aircraft and “dock” with the aircraft. Catering trucks 26, 28, 30 will often comprise a refrigeration unit and other specialized compartments in which the trolleys 8 are stored in transit between the hub distribution center 24 and the aircraft.

In this embodiment of the present invention, products for one flight only are loaded into a specific catering truck. Still referring to FIG. 5, and using catering truck 26 as an example, catering truck 26 does not contain products for catering multiple aircraft. As shown in FIG. 5, when the designated aircraft (denoted herein as “36”) arrives, the catering truck 26 is dispatched and the food products are catered to that aircraft. Once aircraft 36 has been catered, catering truck 26 returns to the hub distribution 24 with inbound material which is unloaded at the hub distribution center 24. Catering truck 26 is then re-loaded with food products for another flight. Multiple catering trucks can be used, the number of such catering trucks dependent on the number of flights desired to be catered. As an example, FIG. 5 shows the use of 3 catering trucks, 26, 28, 30, each catering to aircraft 36, 38, and 40, respectively. At the hub distribution center 24, catering trucks 26, 28 and 30 are each loaded with a specific number of trolleys 8 as required by aircraft 36, 38 and 40, respectively. Once aircraft 36 arrives, catering truck 26 is dispatched for catering. Once aircraft 38 arrives, catering truck 28 is dispatched for catering. Once aircraft 40 arrives, catering truck 30 is dispatched for catering. As it will be understood, catering trucks 28 and 30 are not dispatched until their respective, designated aircraft 38 and 40 arrive. If aircraft 40 arrives ahead of schedule, or if aircraft 40 arrives before aircraft 38, there are no delays in that the products needed to be catered for aircraft 40 are in specific catering truck 30.

Still referring to FIG. 5, in this embodiment, hub distribution center 24 is preferably located within the Airport Operational Area (AOA), and preferably within close proximity to the terminal, although it will be understood that the hub distribution center 24 may be located outside of the AOA. The central distribution center 3 generally is located outside the AOA, but may also be located within the AOA. The distance of the pipeline 22 will vary depending on the geographic locations of the central distribution center 3 and the hub distribution center 24.

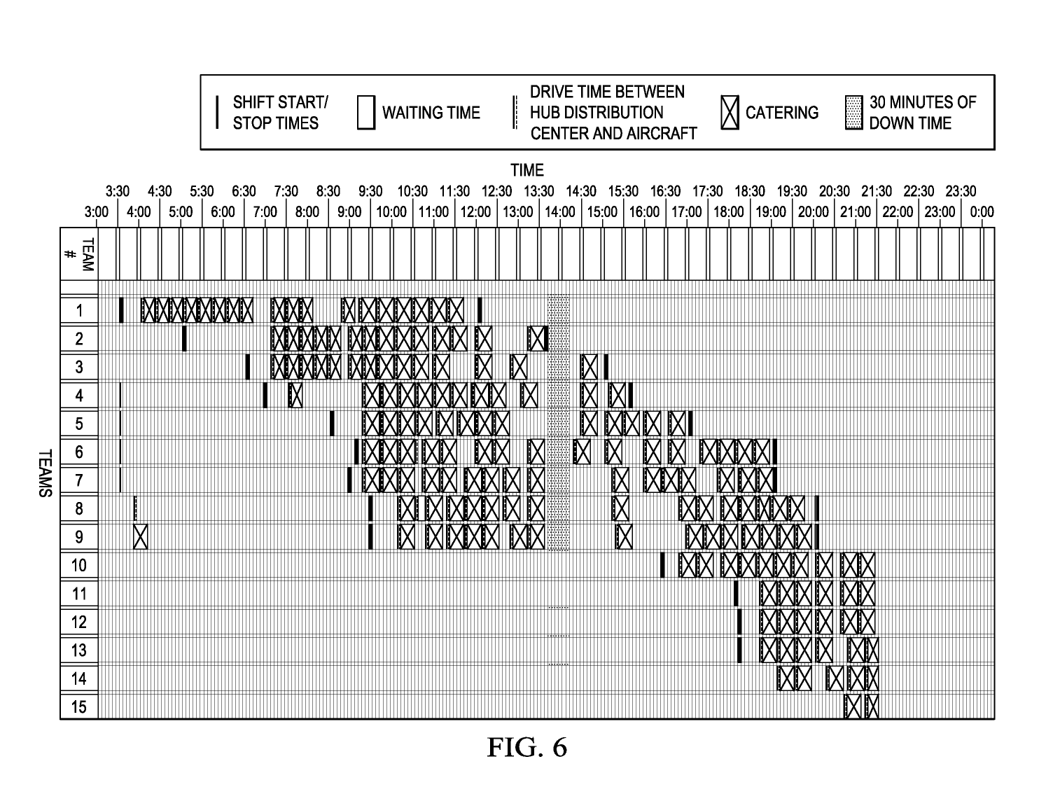

Turning now to FIG. 6, there is shown a flow diagram of time spent on various activities by catering teams catering the example flight schedule of FIG. 3 utilizing the system of catering aircraft referenced in FIG. 5. In this example, 15 teams of drivers (denoted in FIG. 6 as Team #1, Team #2, etc.) were studied to determine the amount of time each team actually spent catering an aircraft during a given day using the method of the present invention illustrated in FIG. 5. The dark solid lines represent the respective shift start/stop times of a given team. The time slots marked with an “X” represent time spent actually catering the various aircraft. The time slots marked with a dashed line represent travel time (between the hub distribution center 24 and aircraft). The time slots that do not contain any marking represent unloading/loading time and waiting time between deliveries.

As shown in FIG. 6, the drive time has substantially decreased (less than 3 minutes between the hub distribution center 24 and aircraft). In addition, there is substantially less waiting time. Further, there is substantial increase in uniformity of the amount of time actually catering aircraft. Furthermore, by utilizing the method of the present invention, the trucks can be driven by one driver per flight and “split catering” can be avoided. In one embodiment of the present invention, the driver may have one or more assistants to help the driver guide the catering truck on and off the aircraft and to assist in catering. However, such assistant(s) would not require the same skill set as compared to a driver, and would require less training. As it will be appreciated, utilizing the improved method results in a more uniform operational mode at both the hub distribution center 24 and the central distribution center 3 wherein the catering distribution system is operated on a regular interval time basis despite changing conditions of an airline aircraft schedule. In one embodiment of the present invention, the assembling of products at the central distribution center 3 occurs at regular time intervals irrespective of changes in an airline flight schedule. In one embodiment of the present invention, the transporting of products from the central distribution center 3 to the hub distribution center 24 occurs at regular time intervals irrespective of changes in an airline flight schedule. In one embodiment of the present invention, the delivery of products from the hub distribution center 24 to the aircraft occurs at regular intervals upon arrival of a given flight and the delivery is not delayed based on changes to other flights in an airline flight schedule. In still another embodiment of the present invention, the number of catering trucks 26 necessary to deliver products from the hub distribution center 24 to an aircraft is less than the number of delivery vehicles required in the traditional catering method referenced in FIG. 1.

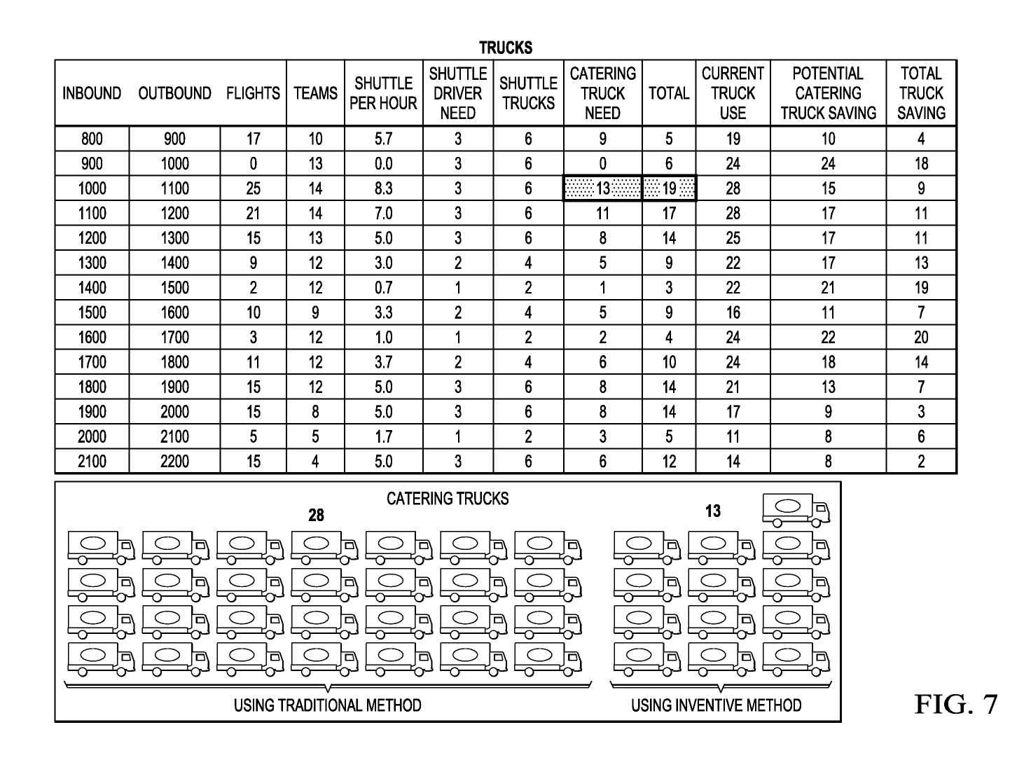

Turning now to FIG. 7, there is illustrated a table which complies the data from FIG. 4 and FIG. 6 and shows how many trucks, shuttles, and drivers would be needed hour by hour utilizing the system of the present invention based on the example airline schedule shown in FIG. 3. As shown in FIG. 7, the “flights” column provides the number of flights in a given hour for Airline “B”. The “teams” column provides an estimate of the number of teams that would be employed in a given hour, based on the number of flights in that hour. The “shuttle trucks” and “shuttle driver need” columns represent the number of shuttle trucks and the number of corresponding drivers needed to meet the present airline schedule. The “catering truck need” column represents the number of catering trucks that would be needed in any given hour based on the current airline schedule. The “current truck use” column shows the number of catering trucks that would be required if operating under the traditional catering method referred to in FIG. 1. As it can be seen, the number of expensive catering trucks required for use using the system of the present invention is substantially lower than that required under the traditional catering system. For example, between the hours of 10:00 AM and 11:00 AM, it is estimated that a total of 28 catering trucks would be needed utilizing the traditional catering system, whereas only 13 would be needed utilizing the system of the present invention, a savings of over 50%, based on the current airline schedule. This number corresponds to savings in fuel, labor and other fixed costs.

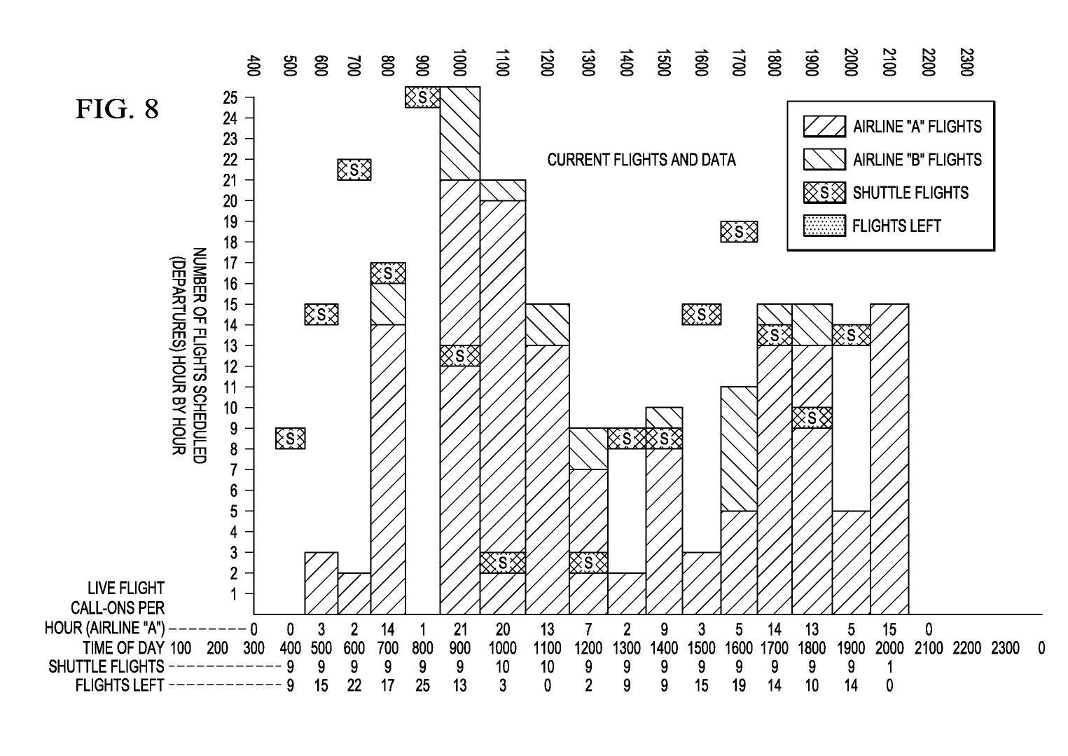

Turning now to FIG. 8, there is shown a graph estimating the number of flights that would be needed to be shuttled hour by hour in the pipeline 22 in accordance with the present invention to meet the example flight schedule of Airline “A” in FIG. 3. As it can be seen, it was estimated that approximately 9 or 10 flights per hour shuttle distribution would be sufficient to meet this schedule. As shown in FIG. 8, the columns marked with diagonal lines moving upward from left to right represent Airline “A” flight schedule and the columns marked with diagonal lines moving upward from right to left represent the Airline “B” flight schedule (the diagonal upward (right to left) portion shows the difference, if any, between the Airline “A” flight schedule and Airline “B” flight schedule—if no right-to-left upward diagonal lined portion is showing, the Airline “A” and Airline “B” schedules are the same). The box marked with an “S” represents the number of flights being shuttled out per the corresponding hour. The designation “flights left” represents the number of flights accumulated at any one time in the hub distribution center 22 and is represented visually by the “S”-marked box on the graph. It will be appreciated that the airline schedule referenced in FIG. 3 is by way of an example only, and the methods and systems of the present invention may be modified to fit various airline schedules.

Although the aforementioned description references specific embodiments and processing techniques of the invention, it is to be understood that these are only illustrative. Additional modifications may be made to the described embodiments and techniques without departing from the spirit and the scope of the invention as defined solely by the appended claims.

What is claimed is:

1. A method of catering aircraft comprising:
assembling products for multiple aircraft in a distribution center;
segregating such products by specific aircraft;
loading onto a delivery vehicle products for catering to a specific aircraft, and
catering such products to such specific aircraft,
wherein the delivery vehicle contains only products for catering to one specific aircraft and does not contain products for catering to multiple aircraft.

2. The method according to claim 1, wherein the distribution center is located outside the airport operational area.

3. The method according to claim 1, wherein the distribution center is located inside the airport operational area.

4. The method according to claim 1, wherein the delivery vehicle is not adapted for docking with an aircraft.

5. The method according to claim 1, wherein the delivery vehicle is adapted for docking with an aircraft.

6. A distribution system for catering aircraft comprising:
assembling products for catering to multiple aircraft at a first distribution center, wherein the first distribution center is located outside the airport operational area;
transporting such products from the first distribution center to a second distribution center, the second distribution center being located inside the airport operational area;
delivering such products from the second distribution center to an aircraft utilizing a delivery vehicle that contains products for only one aircraft and not multiple aircraft.

7. The distribution system according to claim 1, wherein the products comprise food products.

8. The distribution system according to claim 1, wherein the products comprise non-food products.

9. The distribution system according to claim 1, wherein the transporting utilizes a delivery vehicle that is not adapted to dock with an aircraft.

10. The distribution system according to claim 1 further comprising delivering products from an aircraft to the second distribution center and transporting such products from the second distribution center to the first distribution center.

11. The distribution system according to claim 1, wherein the delivery vehicle is adapted to dock with an aircraft.

12. The distribution system according to claim 1, wherein the delivery vehicle is not adapted to dock with an aircraft.

13. A method of operating an aircraft catering distribution system on a regular interval time basis despite changing conditions of an airline aircraft schedule due to uncontrollable factors such as weather, the method comprising:
assembling products for catering to multiple aircraft at a first distribution center, wherein the first distribution center is located outside the airport operational area and wherein the products assembled at such first distribution center in bulk and are ready for delivery to an aircraft and require no further disassembly or assembly upon departure from the first distribution center,
transporting such products from the first distribution center to a second distribution center utilizing a first delivery vehicle, wherein the first delivery vehicle is not adapted for docking to an aircraft, and wherein the second distribution center is located inside the airport operational area;
at the second distribution center, segregating such products that will be catered to specific multiple aircraft,
delivering such products from the second distribution center to an aircraft utilizing a second delivery vehicle, wherein the second delivery vehicle is different from the first delivery vehicle and which can dock with an aircraft.
wherein the catering distribution system is operated on a regular interval time basis despite changing conditions of an airline aircraft schedule.

14. The method of operating an aircraft catering distribution system according to claim 13, wherein the assembling of products at such first distribution center occurs at regular time intervals irrespective of changes in an airline flight schedule.

15. The method of operating an aircraft catering distribution system according to claim 13, wherein the transporting products from the first distribution center to the second distribution center occurs at regular time intervals irrespective of changes in an airline flight schedule.

16. The method of operating an aircraft catering distribution system according to claim 13, wherein the delivery of products from the second distribution center to the aircraft occurs at regular intervals upon arrival of a given flight, said delivery is not delayed based on changes to other flights in an airline flight schedule.

17. The method of operating an aircraft catering distribution system according to claim 13, wherein the number of second delivery vehicles necessary to deliver products from the second distribution center to an aircraft is less than the number of delivery vehicles required in a method of operating an aircraft catering distribution system that does not include a second distribution center.
